(19) United States
(12) Patent Application Publication
(10) Pub. No.: US 2023/0057083 A1
(43) Pub. Date: Feb. 23, 2023

(54) HOT PAGE DETECTION BY SAMPLING TLB RESIDENCY

(71) Applicant: Intel Corporation, Santa Clara, CA (US)

(72) Inventor: Andy Rudoff, Boulder, CO (US)

(21) Appl. No.: 17/818,828

(22) Filed: Aug. 10, 2022

(51) Int. Cl. G06F 12/1027; G06F 12/0811

(52) U.S. Cl. CPC G06F 12/1027; G06F 12/0811; G06F 2212/1016; G06F 2212/681

(57) ABSTRACT

The disclosed technology provides for an improved memory tiering arrangement. In one aspect, an apparatus includes a sampling register and logic, responsive to sequential read requests, to read page data entries stored in successive locations in a TLB and provide page data from the page data entries as sequential outputs of the sampling register. In another aspect, a method includes generating a page residency list based on scanning, via a sampling register, page data entries stored in successive locations in a TLB, determining, for each page, whether the respective page is a hot page or a cold page based on the page residency list, and assigning hot pages to a first memory tier and cold pages to a second memory tier. Scanning page data entries stored in the TLB can include issuing a sequence of read requests to the sampling register sufficient to read all entries in the TLB.

### TECHNICAL FIELD

Embodiments generally relate to computing systems. More particularly, embodiments relate to determining hot pages by sampling translation lookaside buffer (TLB) page residency.

### BACKGROUND

Memory tiering, where data placement changes dynamically based on usage patterns, is growing in popularity due to the high cost of dynamic random access memory (DRAM) and the availability of secondary, lower cost tiers of memory. Memory tiering expands the availability of system memory to applications while reducing page swaps to disk storage. Current memory tiering techniques, however, involve operations that introduce significant performance overhead or otherwise provide suboptimal information upon which to make tiering decisions.

### BRIEF DESCRIPTION OF THE DRAWINGS

The various advantages of the embodiments will become apparent to one skilled in the art by reading the following specification and appended claims, and by referencing the following drawings, in which:

FIG. 1A is a block diagram illustrating a computing system with a conventional memory tiering arrangement;

FIG. 1B is a block diagram illustrating use of a translation lookaside buffer (TLB) for conventional address translation;

FIG. 2 is a block diagram illustrating an example of a performance-enhanced computing system with an improved memory tiering arrangement according to one or more embodiments;

FIGS. 3A-3F provide diagrams illustrating aspects of an example performance-enhanced computing system with an example TLB sampling register according to one or more embodiments;

FIGS. 4A-4B provide diagrams illustrating an example of using a TLB sampling register for memory tiering according to one or more embodiments;

FIG. 5 is a flow diagram illustrating an example method of sequential TLB sampling according to one or more embodiments;

FIG. 6 is a flow diagram illustrating an example method of TLB scanning for memory tiering according to one or more embodiments;

FIG. 7 is a block diagram illustrating an example performance-enhanced computing system employing a memory tiering arrangement according to one or more embodiments; and

FIG. 8 is a block diagram illustrating an example semiconductor apparatus according to one or more embodiments.

### DESCRIPTION OF EMBODIMENTS

A performance-enhanced computing system as described herein provides improved telemetry for selecting hot and cold pages for memory tiering. As described herein, the technology provides a new on-chip sampling register to enable periodic sampling of page residency in a translation lookaside buffer (TLB). Based on TLB page residency statistics, hot and cold pages can be determined for assigning hot pages to a hot memory tier (e.g., highest cost, fastest or highest-performing memory) and cold pages to a cold memory tier (e.g., lower cost, lower-performance memory as compared to the hot memory tier) in a memory tiering arrangement, while bypassing high-overhead or performance-impacting operations such as those that rely on access (“A”) or dirty (“D”) bits. The technology helps improve the overall performance of applications by enhancing the ability to assign hot pages to the hot memory tier and cold pages to the cold memory tier more accurately over time, thus providing faster access to the hottest pages.

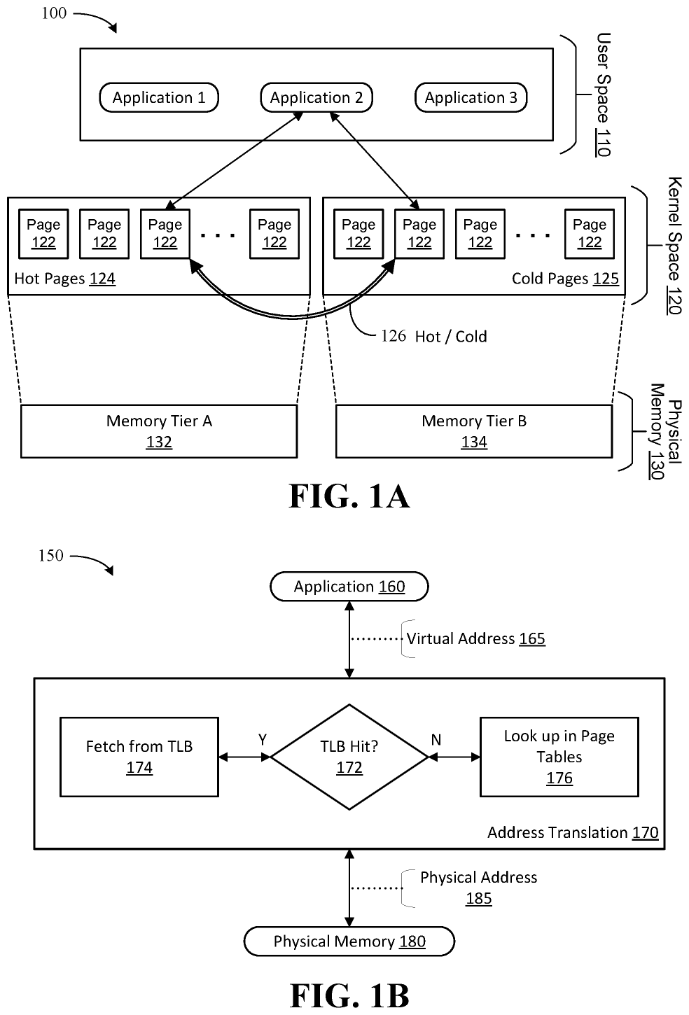

FIG. 1A provides is a block diagram illustrating a computing system 100 with a conventional memory tiering arrangement. As shown in FIG. 1A, the computing system 100 with conventional memory tiering arrangement includes a user space 110, a kernel space 120, and a physical memory layer 130. The user space 110 includes running applications (three applications, Application 1, Application 2, and Application 3 are illustrated in FIG. 1A, but the number of applications can be greater than or less than three). The applications interact with data in one or more memory pages 122. The kernel space 120 is dedicated to an operating system (not shown in FIG. 1A), and is responsible for managing designation of memory pages 122 into hot pages 124 (e.g., a hot page tier) or cold pages 125 (e.g., a cold page tier). Designation of memory pages 122 into hot pages 124 or cold pages 125 is performed via a page designation algorithm or process 126 that attempts to identify which pages are more active (“hot”) and which pages are not as active (“cold”). The physical memory layer 130 includes a first memory tier 132 (memory tier A or hot memory tier) to store hot pages 124 and a second memory tier 134 (memory tier B or cold memory tier) to store cold pages 125. The first memory tier 132 storing hot pages is typically the highest-performance system memory (e.g., DRAM) which, due to cost, is usually limited in capacity. The second memory tier 134 storing cold pages is typically a portion of system memory that is lower-performance and lower cost than DRAM. Page designations as “hot” or “cold” can change over time and result in migration of pages between the hot memory tier 132 and the cold memory tier 134 (and/or movement of pages out of system memory entirely, e.g. to storage or a swap device). Typically, the operating system (OS) tracks page hotness using the page frame number level. When a page is migrated, the page frame number changes, and all virtual mappings to that page in the memory management unit (MMU) (not shown in FIG. 1A) tables are updated to reflect the new location of that page.

In one example, the page designation process 126 includes use of the access (“A”) bit of the MMU. The OS periodically accesses the page tables (e.g., every few seconds), harvesting A bits from the page table entries (PTEs), recording the results in a tracking data structure, clearing the A bits, and finally flushing the PTEs from the translation lookaside buffer (TLB)—an associative cache of PTEs. Over time, the MMU will then take access faults on those pages, setting the associated A bit and indicating hotness. Such a process, however, incurs substantial performance degradation due to the negative effect of page faults as well as the overhead due to flushing entries from the TLB.

FIG. 1B is a block diagram illustrating a process 150 using a TLB for conventional address translation. A TLB is a buffer contained within a central processing unit (CPU) and used by the MMU to cache page table entries which are used to map virtual addresses to physical addresses. Looking up a page table entry (PTE) in the page tables is relatively slow, requiring multiple memory accesses (e.g., a page walk), so a TLB is used to cache those lookups. The first time the application uses a page, its PTE (including the virtual page number and its corresponding page frame number) is looked up and stored in the TLB. The next time the application accesses that page, the PTE is found in the TLB so the translation is much faster. As shown in FIG. 1B, an application 160 attempts to access memory (e.g., application data) having a virtual memory address 165. The computing system has to translate the virtual address via the address translation process 170 into a physical address 185 in order to access the data which is stored in the physical memory 180. The address translation process 170 operates by taking the virtual address 165 and determining whether the virtual address 165 results in a TLB hit (block 172)—that is, whether the page number corresponding to the virtual address 165 is found in the TLB. If so (Yes at block 172), the PTE is fetched from the TLB and used to convert the virtual address 165 to the physical address 185 using the corresponding page frame number in the PTE, thus permitting access to the desired data in the physical memory 180. If there is no TLB hit (No at block 172), meaning that the virtual page number corresponding to the virtual address 165 is not found in the TLB, a page walk occurs where the page tables are accessed via lookup process (block 176) to obtain the PTE corresponding to the virtual page, thus enabling conversion to the physical address 185.

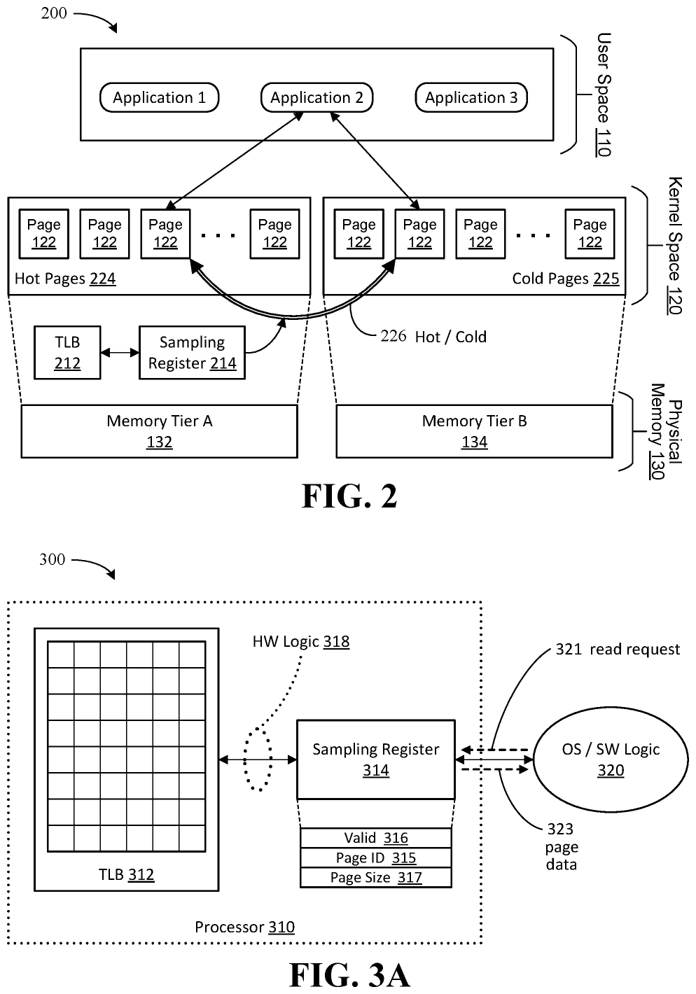

FIG. 2 is a block diagram illustrating an example of a performance-enhanced computing system 200 with an improved memory tiering arrangement according to one or more embodiments, with reference to components and features described herein including but not limited to the figures and associated description. The system 200 includes components and features that are the same as or similar to those in the system 100 (FIG. 1A, already discussed), and those components and features will not be repeated except as necessary to describe the additional components and features shown. The improved memory tiering arrangement as disclosed herein takes advantage of sampling information available in the TLB 212 to provide statistics as to which pages are the subject of recent activity. Because the TLB 212 is high-performance, expensive logic on the CPU chip, it is not practical for the TLB 212 to be large enough to hold all PTEs. When a new PTE is being stored in the TLB 212, an old PTE will be evicted if necessary. As a result, the current PTEs resident in the TLB 212 represent those pages which have recently seen activity. When sampled over time, the TLB page residency provides an indication as to those pages which are currently hot.

As shown in FIG. 2, the system 200 includes a new hardware sampling register 214 to provide rapid access to PTEs in the TLB 212. As described further herein, the sampling register 214 operates via hardware logic, and responsive to prompts or commands from an operating system (OS), to scan the TLB 212 and obtain samples of PTEs resident in the TLB 212. Over time, the PTEs obtained in this scanning process represent a statistical sample of pages resident in the TLB 212 that can be used by the OS via a page designation algorithm or process 226 to determine which pages are hot (e.g., hot pages 224) and which pages are cold (e.g., cold pages 225). Thus, in embodiments the sampling register 214 provides a relaxed access to the TLB 212 that provides a statistical sampling of the TLB 212, while bypassing reliance on related attributes of PTEs in the TLB (such as, e.g., dirty bits or access bits) and/or other aspects of the MMU. That is, the sampling register and its use as disclosed herein targets the statistical state of memory pages. Since the hotness of a page is looked at over time, use of the sampling register 214 as described herein to sample the TLB provides a statistical sample of TLB residency that, over time, will enable the OS to generate a list of hot pages, while avoiding TLB locking. For example, the sampling register samples physical page frame numbers for pages in the TLB.

In embodiments, the sampling register 214 is a read-only register from the perspective of the OS, such that the OS can only read values from the sampling register 214 and cannot write values into the sampling register 214. In embodiments, the sampling register 214 is an architectural model specific register (MSR).

Some or all components or features in the system 200 can be implemented using one or more of a central processing unit (CPU), a graphics processing unit (GPU), an artificial intelligence (AI) accelerator, a field programmable gate array (FPGA) accelerator, an application specific integrated circuit (ASIC), and/or via a processor with software, or in a combination of a processor with software and an FPGA or ASIC. More particularly, components of the system 100 can be implemented in one or more modules as a set of program or logic instructions stored in a machine- or computer-readable storage medium such as random access memory (RAM), read only memory (ROM), programmable ROM (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), FPGAs, complex programmable logic devices (CPLDs), and general purpose microprocessors. Examples of fixed-functionality logic include suitably configured ASICs, combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out operations by the system 200 can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

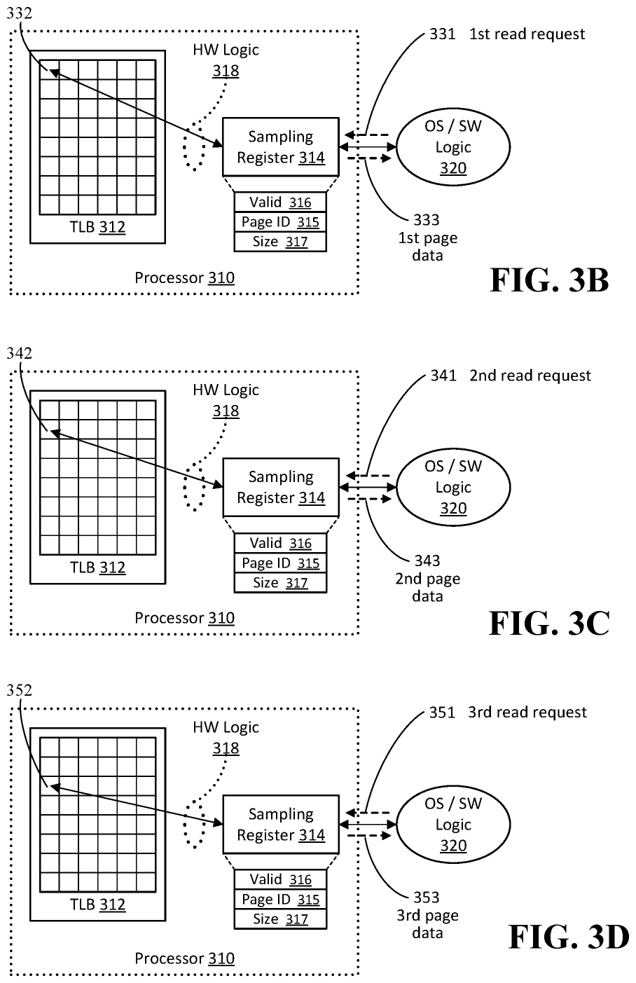

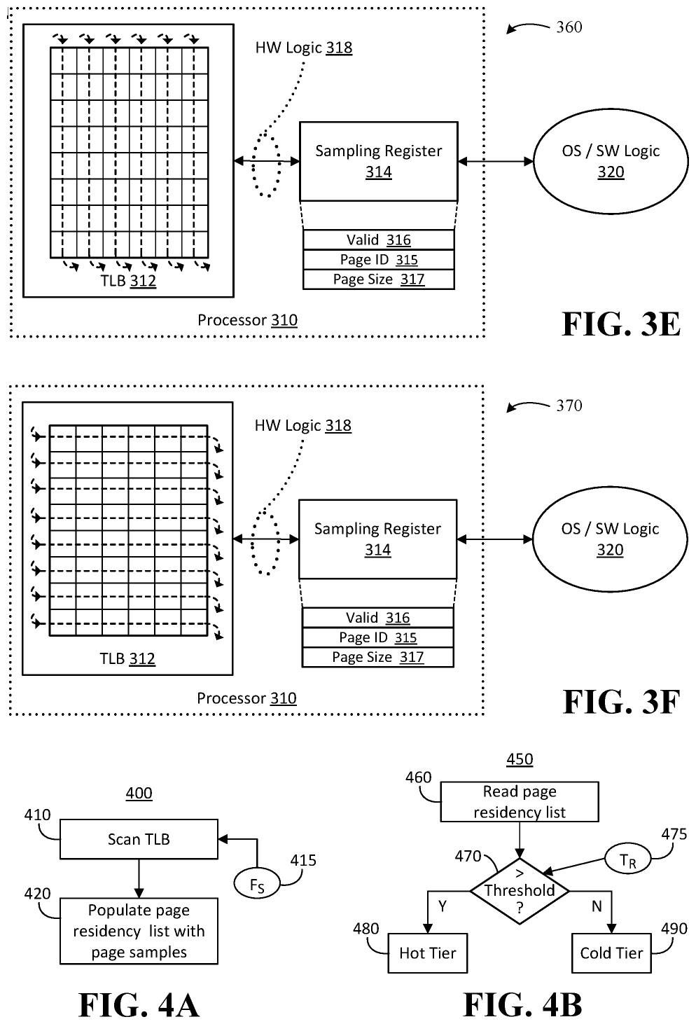

FIG. 3A is a block diagram illustrating an example of a performance-enhanced computing system 300 with an example TLB sampling register according to one or more embodiments, with reference to components and features described herein including but not limited to the figures and associated description. The system 300 includes a processor 310 (e.g., a hardware processor such as a CPU) and an OS/software (SW) logic 320. The processor 310 includes a TLB 312, a sampling register 314, and hardware (HW) logic 318. The TLB corresponds to the TLB 212 (FIG. 2, already discussed). In embodiments, the sampling register 314 corresponds to the sampling register 214 (FIG. 2, already discussed).

In embodiments, the sampling register 314 includes one or more fields, including a page identifier (ID) field 315. The page ID represents page identification information for the PTE at a current read location in the TLB 312 obtained via the HW logic 318. In embodiments, the page ID includes a page frame number (PFN) which identifies the physical page. In some embodiments, the page ID includes a virtual page number (VPN) which identifies the corresponding virtual page (e.g., VPN provided in addition to, or as an alternative to, the PFN). In embodiments, the sampling register 314 also includes additional information from the PTE including, e.g., a valid bit field 316 to hold a valid bit and/or a page entry size field 317 to hold a page size. The valid bit is typically set to “1” to indicate that the page is in memory, and reset to “0” to indicate the page is not yet loaded or is otherwise invalid. The page entry size represents the size of the page (in bytes), and can indicate four kilobytes (4k), two megabytes (2M), 1 gigabyte (1G), etc.

A read request 321 (e.g., a read instruction or a read command) from the OS/SW logic 320 directed to the sampling register 314 triggers a read operation where the sampling register 314, via the HW logic 318, reads PTE data at a location in the TLB. For example, in some embodiments if the sampling register 314 is a model specific register (MSR), an instruction RDMSR can be issued to read the sampling register 314. The PTE page ID data is loaded into the sampling register 314 (specifically, into the page ID field 315 and, when used, the valid bit field 316 and the page size field 317) and provided as page data 323 to the OS/SW logic 320 responsive to the read request 321. The read location is set by the HW logic 318 to the location in the TLB based on the last PTE data read by the sampling register 314. In other words, each time the sampling register 314 receives a read request 321 from the OS/SW logic 320, the read location provides PTE data from the TLB next in succession (e.g., on a column basis or a row basis as explained further herein). In embodiments, the PTE data read responsive to the read request 321 represents a single PTE entry in the TLB 312. That is, each read request 321 results in page data 323 for a single TLB entry. In some embodiments, the page data read responsive to the read request 321 represents multiple PTE entries in the TLB 312; in such embodiments, the page ID field 315 (and when used, the valid bit field 316 and/or the page size field 317) in the sampling register 314 must be of a sufficient size to hold the multiple PTE data, which would be read and unpacked by the OS/SW logic 320.

In some embodiments, different types of read requests can be used to selectively read different amounts of data from the TLB. Thus, for example, a first type of read request (e.g., a first type of read instruction) reads a single PTE entry from a single TLB location, and a second type of read request (e.g., a second type of read instruction) reads multiple (e.g., 2, 3, 4, etc.) PTE entries from multiple successive TLB locations. As such, the OS/SW logic 320 can control the amount of data in each read based on the type of read request issued to the sampling register 314.

FIGS. 3B-3D provide block diagrams illustrating an example of sequential read operations by the sampling register 314 according to one or more embodiments, with reference to components and features described herein including but not limited to the figures and associated description. As shown in FIG. 3B, the OS/SW logic 320 issues a first read request 331 to the sampling register 314. Responsive to the first read request 331, the sampling register, via the HW logic 318, reads page data from a first location 332 in the TLB 312. The page data from the first location 332 is loaded into the appropriate fields of the sampling register 314 (e.g., the page ID field 315, and the valid bit field 316 and/or the page size field 317, when used) and provided to the OS/SW logic 320 as first page data 333.

Turning now to FIG. 3C, as shown the OS/SW logic 320 issues a second read request 341 to the sampling register 314. Responsive to the second read request 341, the sampling register, via the HW logic 318, reads page data from a second location 342 in the TLB 312. The page data from the second location 342 is loaded into the appropriate fields of the sampling register 314 (e.g., the page ID field 315, and the valid bit field 316 and/or the page size field 317, when used) and provided to the OS/SW logic 320 as second page data 343.

Turning now to FIG. 3D, as shown the OS/SW logic 320 issues a third read request 351 to the sampling register 314. Responsive to the third read request 351, the sampling register, via the HW logic 318, reads page data from a third location 352 in the TLB 312. The page data from the third location 352 is loaded into the appropriate fields of the sampling register 314 (e.g., the page ID field 315, and the valid bit field 316 and/or the page size field 317, when used) and provided to the OS/SW logic 320 as third page data 353.

The HW logic 318 tracks the appropriate location in the TLB 312 for each successive read by the sampling register 314 as triggered by successive read requests from the OS/SW logic 320. For example, after each read by the sampling register 314 the HW logic 318 advances the read location in the TLB to the next location in the TLB (e.g., on a column basis or a row basis) following the location containing the data from that read. In one example, the HW logic 318 can track the read location via a row counter and a column counter. As the OS/SW logic 320 issues sequential read requests (e.g., the first, second and third read requests 331, 341 and 351 as illustrated in FIGS. 3B-3D), the sampling register 314 and HW logic 318 operate to read entries from successive locations in the TLB 312 (e.g., the first, second and third locations 332, 342 and 352 in FIGS. 3B-3D), and provide the page data as sequential outputs (e.g., the first, second and third page data outputs 333, 343 and 353 as illustrated in FIGS. 3B-3D) from the sampling register 314 back to the OS/SW logic 320. In the example of FIGS. 3B-3D, the TLB 312 is read on a column basis, one PTE entry per read request. Alternatively, in some embodiments the TLB 312 can be read on a row basis. In some embodiments, more than one PTE entry is read each time a read request is issued, in which case the read location advances the appropriate number of locations matching the number of entries read.

FIGS. 3E-3F provide block diagrams illustrating examples of TLB scanning operations by HW logic 318 in conjunction with the sampling register 314 according to one or more embodiments, with reference to components and features described herein including but not limited to the figures and associated description. The examples illustrate scanning of the TLB 312 on a column-by-column basis 360 (FIG. 3E) or a row-by-row basis 370 (FIG. 3F), as determined by the HW logic 318. As shown in FIG. 3E, the TLB 312 is scanned on a column-by-column basis by the sampling register 314 (responsive to one or more read requests 321 from the OS/SW logic 320). Thus, with reference to the examples illustrated in FIGS. 3B-3D, the TLB 312 is scanned in successive locations column-by-column. When the end of the last column is reached (lower right column), the scan returns to the beginning of the TLB 312 (upper left column) and proceeds back through the TLB 312. In this way, the entire TLB 312 is scanned on a periodic basis, with each scan completed based on the frequency at which the OS/SW logic 320 issues read requests 321 and the amount of PTE data read in response to each read request (in view of the size of the TLB 312). In the case where a single PTE is read for each read request 321, the TLB scan timing is based on the frequency of read requests 321 and the size of the TLB 312.

As shown in FIG. 3F, as an alternative the TLB 312 is scanned in successive locations on a row-by row basis by the sampling register 314 (responsive to one or more read requests 321 from the OS/SW logic 320). When the end of the last row is reached (lower right row), the scan returns to the beginning of the TLB 312 (upper left row) and proceeds back through the TLB 312. In this way, the entire TLB 312 is scanned on a periodic basis, with each scan completed based on the frequency at which the OS/SW logic 320 issues read requests 321 and the amount of PTE data read in response to each read request (in view of the size of the TLB 312). In the case where a single PTE is read for each read request 321, the TLB scan timing is based on the frequency of read requests 321 and the size of the TLB 312.

FIGS. 4A-4B provide diagrams illustrating an example of using TLB sampling for memory tiering according to one or more embodiments, with reference to components and features described herein including but not limited to the figures and associated description. The processes described with reference to FIGS. 4A-4B utilize the TLB sampling as described herein with reference to FIGS. 2 and 3A-3F. In FIG. 4A, a process 400 for generating a page residency list begins at block 410, which provides for scanning the TLB. Scanning the TLB (such as, e.g., the TLB 312) is accomplished as described herein with reference to FIGS. 3A-3F. At block 420, the samples obtained during the TLB scanning of block 410 are used to populate a page residency list.

The operations of blocks 410 and 420 can occur essentially contemporaneously, with TLB samples collected and corresponding pages placed in the page residency list as the samples are received, etc. Thus, the page residency list is generated/updated as the samples are collected by the sampling register 314 and passed to the OS/SW logic 320. The page residency list provides a cumulative list over time in that information from previous TLB scans remains in the list to provide a recent historical perspective as to which pages remain hot and which pages are getting cold. As an example, in some embodiments the page residency list includes a timestamp for each page in the list to indicate the time at which the page is seen in the TLB, which can be used to determine hot/cold pages (e.g., based on a threshold parameter). Thus, in some embodiments, for example, the page residency list can be used to track pages that are “decaying” over time into cold pages based on disappearance of the pages from the most recent TLB scans.

Block 415 provides a sampling frequency parameter F_{S} (e.g., the frequency at which read requests 321 are issued to the sampling register 314), which can be predetermined or set by the OS/SW logic 320. The OS/SW logic 320 can choose a sampling frequency parameter F_{S} to a rate that meets the telemetry needs of the memory tiering algorithm—for example, a rate that provides for scanning all entries of the TLB every X seconds, based on the size of the TLB. As one example, the OS/SW logic 320 might set the sampling frequency parameter F_{S} to read 1000 samples every second, making its way through all TLB entries over the course of a few seconds (depending on the size of the TLB). In some embodiments, the OS/SW logic 320 will ignore entries where the valid bit (if present via the sampling register 314) is clear (e.g., reset to “0”).

In FIG. 4B, a process 450 for assigning pages begins at block 460, which provides for reading the page residency list (i.e., the page residency list generated by the process 400 in FIG. 4A). At block 470, each page reflected in the page residency list is compared to a threshold. If the page has been resident in the TLB for greater than a threshold time or threshold number of samples (Y at block 470), the page is determined to be a hot page and assigned to a first memory tier (such as, e.g., the hot memory tier 132 in FIGS. 1 and 2) at block 480. If the page has been resident in the TLB for less than the threshold time or threshold number of samples (N at block 470), the page is determined to be a cold page and assigned to a second memory tier (such as, e.g., the cold memory tier 134 in FIGS. 1 and 2) at block 490. For example, as described above with reference to FIG. 4A the page residency list can be used to track pages that are “decaying” over time into cold pages based on disappearance from the most recent TLB scans, and a threshold value can be set to establish a point where the “decay” results in a page being designated as a cold page.

Block 475 provides a threshold residency parameter T_{R}, which can be predetermined or set by the OS/SW logic 320. For example, the threshold residency parameter T_{R} can be set to establish a residency “decay” rate where a formerly hot page is designated as cold (e.g., once the residency for a hot page decays beyond the threshold the page is designated as cold). As an example, in some embodiments the page residency list includes a timestamp for each page in the list to indicate the time at which the page is seen in the TLB. When the last time a page was seen exceeds a threshold (e.g., the threshold residency parameter T_{R}), the page is removed from the list. The sampling frequency parameter F_{S} (block 415) and the threshold residency parameter T_{R} (block 475) thus provide the OS/SW logic 320 with the ability to tune the processes 400 and 450 to meet the needs of memory tiering. At intervals determined by the OS, pages are migrated between the hot memory tier and the cold memory tier based on the hot page/cold page designations.

In some embodiments, the TLB sampling as described herein can be used by the OS or other software logic (e.g., the OS/SW logic 320) for additional performance monitoring purposes. For example, collection of TLB page samples over time (e.g., in a page residency list) can be used to detect when there is a large or rapid turnover of pages in the TLB, which would indicate TLB thrashing. As another example, individual page residency can be monitored to detect and track how long specific identified pages remain in the TLB over time.

The process 400 and/or the process 450 can generally be implemented in the system 200 (FIG. 2, already discussed), e.g., as portions of the page designation process 226. More particularly, the process 400 and/or the process 450 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the process 400 and/or the process 450 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

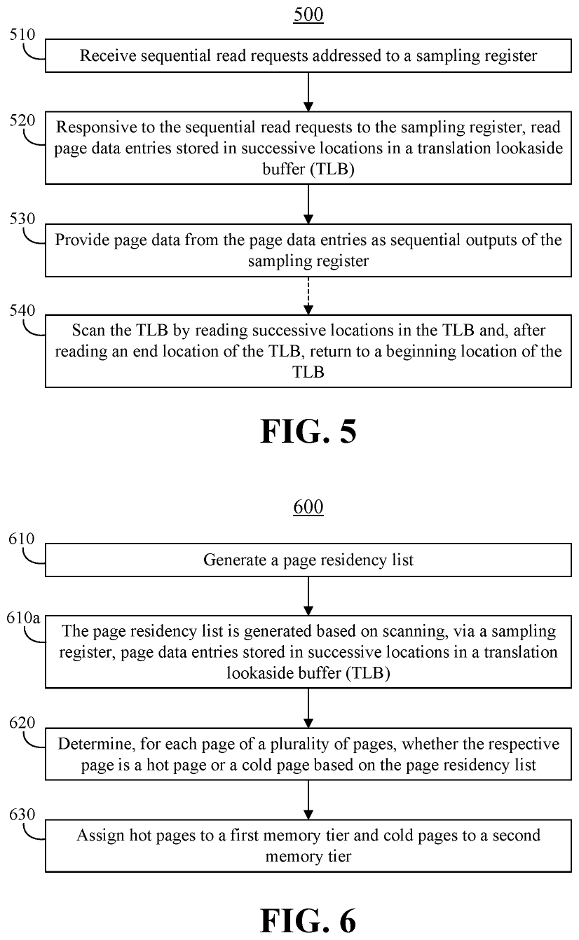

FIG. 5 provides a flow diagram illustrating an example method 500 of sequential TLB sampling according to one or more embodiments, with reference to components and features described herein including but not limited to the figures and associated description. The method 500 can generally be implemented in the system 200 (FIG. 2, already discussed) and/or the system 300 (FIG. 3, already discussed) and/or via components thereof. More particularly, the method 500 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 500 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 510 provides for receiving sequential read requests addressed to a sampling register. Illustrated processing block 520 provides for, responsive to the sequential read requests to the sampling register, reading page data entries stored in successive locations in a translation lookaside buffer (TLB). Illustrated processing block 530 includes providing page data from the page data entries as sequential outputs of the sampling register. The operations of blocks 510, 520 and 530 can occur essentially contemporaneously; that is, as each read request is received (block 510), page data is read from a location in the TLB (block 520), and the page data is output via the sampling register (block 530).

In some embodiments, the sampling register includes a page identifier (ID) field, and the sequential outputs each include one or more page identifiers for the page data at the respective location in the TLB. In some embodiments, the sampling register further includes one or more of a valid bit field or a page size field.

In some embodiments, illustrated processing block 540 provides for scanning the TLB by reading successive locations in the TLB and, after reading an end location of the TLB, returning to a beginning location of the TLB. In some embodiments, the TLB is scanned on one of a column-by column basis or a row-by row basis.

In some embodiments, each read request results in reading a single page table entry in the TLB. In some embodiments, for each read request a number of page table entries is read based on a type of the respective read request.

FIG. 6 provides a flow chart illustrating an example method 600 of TLB scanning for memory tiering according to one or more embodiments, with reference to components and features described herein including but not limited to the figures and associated description. The method 600 can generally be implemented in the system 200 (FIG. 2, already discussed) and/or the system 300 (FIG. 3, already discussed) and/or via components thereof. More particularly, the method 600 can be implemented as one or more modules as a set of logic instructions stored in a machine- or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out operations shown in the method 600 and/or functions associated therewith can be written in any combination of one or more programming languages, including an object oriented programming language such as JAVA, SMALLTALK, C++ or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 610 provides for generating a page residency list based (block 610a) on scanning, via a sampling register, page data entries stored in successive locations in a translation lookaside buffer (TLB). Illustrated processing block 620 provides for determining, for each page of a plurality of pages, whether the respective page is a hot page or a cold page based on the page residency list. Illustrated processing block 630 provides for assigning hot pages to a first memory tier and cold pages to a second memory tier.

In some embodiments, scanning, via the sampling register, page data entries stored in the TLB comprises issuing a sequence of read requests to the sampling register sufficient to read all entries in the TLB. In some embodiments, the read requests are issued at a frequency based on a sampling frequency parameter. In some embodiments, the sampling frequency parameter is set based on a size of the TLB. In some embodiments, determining whether the respective page is a hot page or a cold page is further based on a threshold residency parameter. In some embodiments, the threshold residency parameter is set based on a residency decay rate. The residency decay rate can be, e.g., a rate (e.g., timeframe) in which a page is not seen in the TLB, which in some embodiments can be tracked based on a timestamp applied to each page in the page residency list.

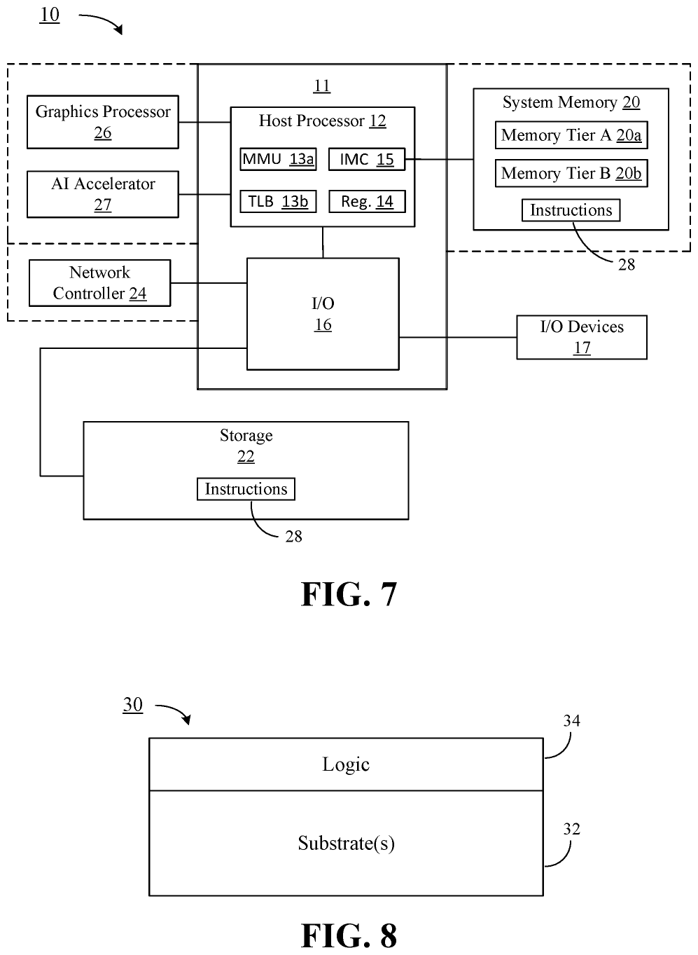

Embodiments of each of the above systems, devices, components and/or methods, including the system 200, the system 300, the processor 310, the process 400, the process 450, the method 500, and/or the method 550, and/or any other system components, can be implemented in hardware, software, or any suitable combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits. For example, embodiments of each of the above systems, devices, components and/or methods can be implemented via the system 10 (FIG. 7, discussed further below), and/or the semiconductor apparatus 30 (FIG. 8, discussed further below).

Alternatively, or additionally, all or portions of the foregoing systems and/or devices and/or components and/or methods can be implemented in one or more modules as a set of program or logic instructions stored in a machine- or computer-readable storage medium such as RAM, ROM, PROM, firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

FIG. 7 is a block diagram illustrating an example performance-enhanced computing system 10 according to one or more embodiments, with reference to components and features described herein including but not limited to the figures and associated description. The system 10 can be used for employing a memory tiering arrangement in accordance with embodiments. The system 10 can generally be part of an electronic device/platform having computing and/or communications functionality (e.g., a server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry, or other wearable devices), vehicular functionality (e.g., car, truck, motorcycle), robotic functionality (e.g., robot or autonomous robot), Internet of Things (IoT) functionality, etc., or any combination thereof. In the illustrated example, the system 10 can include a host processor 12 (e.g., central processing unit/CPU) having an integrated memory controller (IMC) 15 that can be coupled to system memory 20. The host processor 12 can include any type of processing device, such as, e.g., microcontroller, microprocessor, RISC processor, ASIC, etc., along with associated processing modules or circuitry. In embodiments the host processor 12 also includes a MMU 13a, a TLB 13b, and a sampling register 14 for sampling the TLB 13b.

The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28. The system memory 20 can include two or more memory tiers, such as a first memory tier 20A (labelled as Memory Tier A) and a second memory tier 20B (labelled as Memory Tier B). The first memory tier 20A can be comprised of a different memory type than the second memory tier 20B. For example, the first memory tier 20A can include high-performing DRAM, while the second memory tier 20B can include memory of a lower cost and lower performance than DRAM (such as, e.g., Intel® Optane™ memory). Other memory tier configurations are possible. In some embodiments, the first memory tier 20A and the second memory tier 20B can be organized as a database.

The system 10 can also include an input/output (I/O) module 16. The I/O module 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/or the I/O module 16 can communicate with the storage 22 (all or portions thereof) via a network controller 24. In some embodiments, the system 10 can also include a graphics processor 26 (e.g., a graphics processing unit/GPU. In some embodiments, the system 10 can also include a graphics processor 26 (e.g., a graphics processing unit/GPU) and/or an AI accelerator 27. In an embodiment, the system 10 can also include a vision processing unit (VPU), not shown.

The host processor 12 and the I/O module 16 can be implemented together on a semiconductor die as a system on chip (SoC) 11, shown encased in a solid line. The SoC 11 can therefore operate as a computing apparatus for memory tiering based on TLB scanning using a TLB sampling register. In some embodiments, the SoC 11 can also include one or more of the system memory 20, the network controller 24, and/or the graphics processor 26 (shown encased in dotted lines). In some embodiments, the SoC 11 can also include other components of the system 10.

The host processor 12 and/or the I/O module 16 can execute program instructions 28 retrieved from the system memory 20 and/or the storage 22 to perform one or more aspects of the process 400 (FIG. 4A), the process 450 (FIG. 4B), and/or the method 600 (FIG. 6). In embodiments, the host processor 12 includes logic (e.g., configurable hardware, fixed-functionality hardware, etc., or any combination thereof) to implement one or more aspects of the method 500 (FIG. 5). The system 10 can implement one or more aspects of the system 200, the system 300, and/or the processor 310 (FIGS. 2, 3A-3F). The system 10 is therefore considered to be performance-enhanced at least to the extent that the technology provides the ability to determine hot and cold pages based on TLB residency and assign pages to a hot memory tier or a cold memory tier, respectively, while bypassing high-overhead or performance-impacting operations.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touchscreen, keyboard, mouse, cursor-control device, microphone, digital camera, video recorder, camcorder, biometric scanners and/or sensors; input devices can be used to enter information and interact with the system 10 and/or with other devices. The I/O devices 17 can also include one or more of output devices, such as a display (e.g., touch screen, liquid crystal display/LCD, light emitting diode/LED display, plasma panels, etc.), speakers and/or other visual or audio output devices. The input and/or output devices can be used, e.g., to provide a user interface.

FIG. 8 is a block diagram illustrating an example semiconductor apparatus 30 according to one or more embodiments, with reference to components and features described herein including but not limited to the figures and associated description. The apparatus 30 can be used in a system employing a memory tiering arrangement in accordance with embodiments. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 7. The logic 34 can implement one or more aspects of the processes described above, including the process 400 (FIG. 4A), the process 450 (FIG. 4B), the method 500 (FIG. 5), and/or the method 600 (FIG. 6). The logic 34 can implement one or more aspects of the system 200, the system 300, and/or the processor 310 as described herein with reference to FIGS. 2 and 3A-3F. The apparatus 30 is therefore considered to be performance-enhanced at least to the extent that the technology provides the ability to determine hot and cold pages based on TLB residency and assign pages to a hot memory tier or a cold memory tier, respectively, while bypassing high-overhead or performance-impacting operations.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 34.

### Additional Notes and Examples

Example 1 includes a semiconductor apparatus comprising one or more substrates, a sampling register coupled to the one or more substrates, and logic coupled to the one or more substrates, where the logic is implemented at least partly in one or more of configurable or fixed-functionality hardware, the logic to responsive to sequential read requests to the sampling register, read page data entries stored in successive locations in a translation lookaside buffer (TLB), and provide page data from the page data entries as sequential outputs of the sampling register.

Example 2 includes the semiconductor apparatus of Example 1, where the sampling register includes a page identifier (ID) field, and the sequential outputs each include one or more page identifiers for the page data at the respective location in the TLB.

Example 3 includes the semiconductor apparatus of Example 1 or 2, where the sampling register further includes one or more of a valid bit field or a page size field.

Example 4 includes the semiconductor apparatus of Example 1, 2 or 3, where the logic is to scan the TLB by reading successive locations in the TLB and, after reading an end location of the TLB, return to a beginning location of the TLB.

Example 5 includes the semiconductor apparatus of any of Examples 1-4, where the logic is to scan the TLB on one of a column-by column basis or a row-by row basis.

Example 6 includes the semiconductor apparatus of any of Examples 1-5, where each read request results in reading a single page table entry in the TLB.

Example 7 includes the semiconductor apparatus of any of Examples 1-6, where for each read request the logic is to read a number of page table entries based on a type of the respective read request.

Example 8 includes an enhanced computing system comprising a first memory tier, a second memory tier, and a processor coupled to the first memory tier and to the second memory tier, where the processor includes a sampling register and logic implemented at least partly in one or more of configurable or fixed-functionality hardware, the logic to responsive to sequential read requests to the sampling register, read page data entries stored in successive locations in a translation lookaside buffer (TLB), and provide page data from the page data entries as sequential outputs of the sampling register.

Example 9 includes the computing system of Example 8, where the sampling register includes a page identifier (ID) field, and the sequential outputs each include one or more page identifiers for the page data at the respective location in the TLB.

Example 10 includes the computing system of Example 8 or 9, where the logic is to scan the TLB by reading successive locations in the TLB and, after reading an end location of the TLB, return to a beginning location of the TLB.

Example 11 includes the computing system of Example 8, 9 or 10, where the logic is to scan the TLB on one of a column-by column basis or a row-by row basis, and where each read request results in reading a single page table entry in the TLB.

Example 12 includes the computing system of any of Examples 8-11, further comprising a memory to store instructions which, when executed by the processor, cause the computing system to generate a page residency list based on scanning the TLB via the sampling register, determine, for each page of a plurality of pages, whether the respective page is a hot page or a cold page based on the page residency list, and assign hot pages to the first memory tier and cold pages to the second memory tier.

Example 13 includes the computing system of any of Examples 8-12, where the read requests are issued at a frequency based on a sampling frequency parameter, and where the sampling frequency parameter is set based on a size of the TLB.

Example 14 includes the computing system of any of Examples 8-13, where determining whether the respective page is a hot page or a cold page is further based on a threshold residency parameter, and where the threshold residency parameter is set based on a residency decay rate.

Example 15 includes a method comprising generating a page residency list based on scanning, via a sampling register, page data entries stored in successive locations in a translation lookaside buffer (TLB), determining, for each page of a plurality of pages, whether the respective page is a hot page or a cold page based on the page residency list, and assigning hot pages to a first memory tier and cold pages to a second memory tier.

Example 16 includes the method of Example 15, where scanning, via the sampling register, page data entries stored in the TLB comprises issuing a sequence of read requests to the sampling register sufficient to read all entries in the TLB.

Example 17 includes the method of Example 15 or 16, where the read requests are issued at a frequency based on a sampling frequency parameter.

Example 18 includes the method of Example 15, 16 or 17, where the sampling frequency parameter is set based on a size of the TLB.

Example 19 includes the method of any of Examples 15-18, where determining whether the respective page is a hot page or a cold page is further based on a threshold residency parameter.

Example 20 includes the method of any of Examples 15-19, where the threshold residency parameter is set based on a residency decay rate.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

I claim:

1. A semiconductor apparatus comprising:
one or more substrates;
a sampling register coupled to the one or more substrates; and
logic coupled to the one or more substrates, wherein the logic is implemented at least partly in one or more of configurable or fixed-functionality hardware, the logic to:
responsive to sequential read requests to the sampling register, read page data entries stored in successive locations in a translation lookaside buffer (TLB); and
provide page data from the page data entries as sequential outputs of the sampling register.

2. The semiconductor apparatus of claim 1, wherein the sampling register includes a page identifier (ID) field, and the sequential outputs each include one or more page identifiers for the page data at the respective location in the TLB.

3. The semiconductor apparatus of claim 2, wherein the sampling register further includes one or more of a valid bit field or a page size field.

4. The semiconductor apparatus of claim 1, wherein the logic is to scan the TLB by reading successive locations in the TLB and, after reading an end location of the TLB, return to a beginning location of the TLB.

5. The semiconductor apparatus of claim 4, wherein the logic is to scan the TLB on one of a column-by column basis or a row-by row basis.

6. The semiconductor apparatus of claim 1, wherein each read request results in reading a single page table entry in the TLB.

7. The semiconductor apparatus of claim 1, wherein for each read request the logic is to read a number of page table entries based on a type of the respective read request.

8. A computing system comprising:
a first memory tier;
a second memory tier; and
a processor coupled to the first memory tier and to the second memory tier, wherein the processor includes a sampling register and logic implemented at least partly in one or more of configurable or fixed-functionality hardware, the logic to:
responsive to sequential read requests to the sampling register, read page data entries stored in successive locations in a translation lookaside buffer (TLB); and
provide page data from the page data entries as sequential outputs of the sampling register.

9. The computing system of claim 8, wherein the sampling register includes a page identifier (ID) field, and the sequential outputs each include one or more page identifiers for the page data at the respective location in the TLB.

10. The computing system of claim 9, wherein the logic is to scan the TLB by reading successive locations in the TLB and, after reading an end location of the TLB, return to a beginning location of the TLB.

11. The computing system of claim 10, wherein the logic is to scan the TLB on one of a column-by column basis or a row-by row basis, and wherein each read request results in reading a single page table entry in the TLB.

12. The computing system of claim 10, further comprising a memory to store instructions which, when executed by the processor, cause the computing system to:
generate a page residency list based on scanning the TLB via the sampling register;
determine, for each page of a plurality of pages, whether the respective page is a hot page or a cold page based on the page residency list; and
assign hot pages to the first memory tier and cold pages to the second memory tier.

13. The computing system of claim 12, wherein the read requests are issued at a frequency based on a sampling frequency parameter, and wherein the sampling frequency parameter is set based on a size of the TLB.

14. The computing system of claim 12, wherein determining whether the respective page is a hot page or a cold page is further based on a threshold residency parameter, and wherein the threshold residency parameter is set based on a residency decay rate.

15. A method comprising:
generating a page residency list based on scanning, via a sampling register, page data entries stored in successive locations in a translation lookaside buffer (TLB);
determining, for each page of a plurality of pages, whether the respective page is a hot page or a cold page based on the page residency list; and
assigning hot pages to a first memory tier and cold pages to a second memory tier.

16. The method of claim 15, wherein scanning, via the sampling register, page data entries stored in the TLB comprises issuing a sequence of read requests to the sampling register sufficient to read all entries in the TLB.

17. The method of claim 16, wherein the read requests are issued at a frequency based on a sampling frequency parameter.

18. The method of claim 17, wherein the sampling frequency parameter is set based on a size of the TLB.

19. The method of claim 15, wherein determining whether the respective page is a hot page or a cold page is further based on a threshold residency parameter.

20. The method of claim 19, wherein the threshold residency parameter is set based on a residency decay rate.
